(19) United States
(12) Patent Application Publication
(10) Pub. No.: US 2016/0361950 A1
(43) Pub. Date: Dec. 15, 2016

(54) REINFORCEMENT CORD WITH RADIATION CONTRAST

(71) Applicant: ANALOGIC CORPORATION, Peabody, MA (US)

(72) Inventors: Charles H. Shaughnessy, Hamilton, MA (US); Eric Zanin, Lexington, MA (US)

(21) Appl. No.: 15/114,204

(22) PCT Filed: Feb. 13, 2014
(86) PCT No.: PCT/US2014/016214

§ 371 Date: Jul. 26, 2016

(51) Int. Cl. B60C 9/00; G01N 23/04

(52) U.S. Cl. CPC B60C 9/005; B60C 9/0042; B60C 9/0007; B60C 9/0028; G01N 23/046; B60C 2009/0071; G01N 2223/627

(57) ABSTRACT

A reinforcement cord which comprises a first fiber (302) having a first radiation attenuation coefficient. The reinforcement cord also comprises a contrast agent applied to the first fiber. The contrast agent has a second radiation attenuation coefficient that is different (e.g., greater) than that of the first radiation attenuation coefficient. In some embodiments, the reinforcement cord is incorporated into a composite product, such as a tire. In some embodiments, the contrast agent improves and/or enhances the discernibility of the reinforcement cord in a composite product during a radiation examination, such as a computed tomography (CT) scan. A method of manufacturing the reinforcement cord is also disclosed.

### BACKGROUND

The present application relates to the field of radiation imaging and in particular to the use of a contrasting agent that is applied to an aspect of an object to alter a radiation contrast between the aspect and other aspects of the object. It finds particular application with respect to reinforcement cords for use in articles such as, tires and/or other composite products.

Manufactured composite products, such as tires, wall dividers, etc., sometimes include reinforcement cords to provide (e.g., increase) the tensile strength and/or compressive strength of the composite product, for example. In general, these composite products contain a matrix comprising a rubber or other suitable material which is reinforced by a cord obtained by coating a fiber or a twisted fiber bundle with an adhesive to form the reinforcement cord. By way of example, in a tire, reinforcement cords can be used in different areas where reinforcement of a material is desirable. For example, reinforcement cords can be used in the carcass, as a reinforcing ply, in a sidewall region, belt region or breaker structure, as primary reinforcing plies, or as overlays/underlays in the bead region as flipper or chipper plies, for example. In respective parts of the tire, the reinforcement cords are relied upon to provide properties specific to that region of the tire. For instance, the reinforcement cords can give a tire its shape, size, stability, load carrying capacity, fatigue resistance characteristics, and/or bruise resistance characteristics.

The placement and/or relative location of these reinforcement cords within the composite product is important or the composite product may not perform properly and/or may fail. One technique for verifying the correct placement of these reinforcement cords has involved deconstructing a sample number of the composite products. Accordingly, a specified number of products are deconstructed to view the reinforcement cords and/or verify proper positioning within the composite product.

### SUMMARY

Aspects of the present application address the above matters, and others. According to one aspect, a reinforcement cord is provided. The reinforcement cord comprises a first fiber having a first radiation attenuation coefficient. The reinforcement cord also comprises a contrast agent applied to the first fiber. The contrast agent has a second radiation attenuation coefficient different than that of the first radiation attenuation coefficient.

According to another aspect, a tire is provided. The tire comprises a matrix and a reinforcement cord in the matrix. The reinforcement cord comprises a first fiber having a first radiation attenuation coefficient. The reinforcement cord also comprises a contrast agent applied to the first fiber. The contrast agent has a second radiation attenuation coefficient different than that of the first radiation attenuation coefficient.

According to another aspect, a method of manufacturing a reinforcement cord is provided. The method comprising providing a first fiber having a first radiation attenuation coefficient. The method also comprising applying a contrast agent to the first fiber, wherein the contrast agent has a second radiation attenuation coefficient different than that of the first radiation attenuation coefficient.

Those of ordinary skill in the art will appreciate still other aspects of the present application upon reading and understanding the appended description.

### FIGURES

The application is illustrated by way of example and is not limited by the figures of the accompanying drawings, in which like references generally indicate similar elements and in which:

FIG. 1 illustrates an example radiation system.

FIG. 2 is a flow diagram illustrating an example method for fabricating a reinforcement cord.

FIG. 3a illustrates a perspective view of a reinforcement cord according to some embodiments.

FIG. 3b illustrates a perspective view of a reinforcement cord according to some embodiments.

FIG. 4a illustrates a perspective view of a reinforcement cord according to some embodiments.

FIG. 4b illustrates a perspective view of a reinforcement cord according to some embodiments.

FIG. 5 illustrates a CT scan of a reinforcement cord of the present disclosure according to some embodiments.

FIG. 6 illustrates a perspective view of a composite product according to some embodiments.

FIG. 7 illustrates a cross-sectional view of a tire according to some embodiments.

FIG. 8 is a flow diagram illustrating an example method for examining a composite product, such as a tire, via a radiation system according to some embodiments.

FIG. 9 is an illustration of an example computer-readable medium comprising processor-executable instructions configured to embody one or more of the provisions set forth herein.

### DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

Among other things, one or more systems and/or techniques are provided for imaging a composite product to verify the position of a reinforcement cord and/or to detect defects within the composite product (e.g., such as defects within the reinforcement cord). Prior to constructing the composite product, a contrasting agent is applied to the reinforcement cord. For example, the contrasting agent is sprayed onto the reinforcement cord and/or otherwise applied to the reinforcement cord in a manner that causes the contrasting agent to saturate and/or coat the reinforcement cord. The contrasting agent is configured to alter an x-ray attenuation characteristic of the reinforcement cord (e.g., to facilitate improved contrast during a radiation examination of the composite product, including the reinforcement cord). Subsequently, when the composite product is examined via a radiation system, such as a computed tomography (CT) system, the reinforcement cord is distinguishable from other aspects of the object/composite product in resulting images (e.g., to facilitate analysis of the reinforcement cord by a feature identification component and/or by a technician).

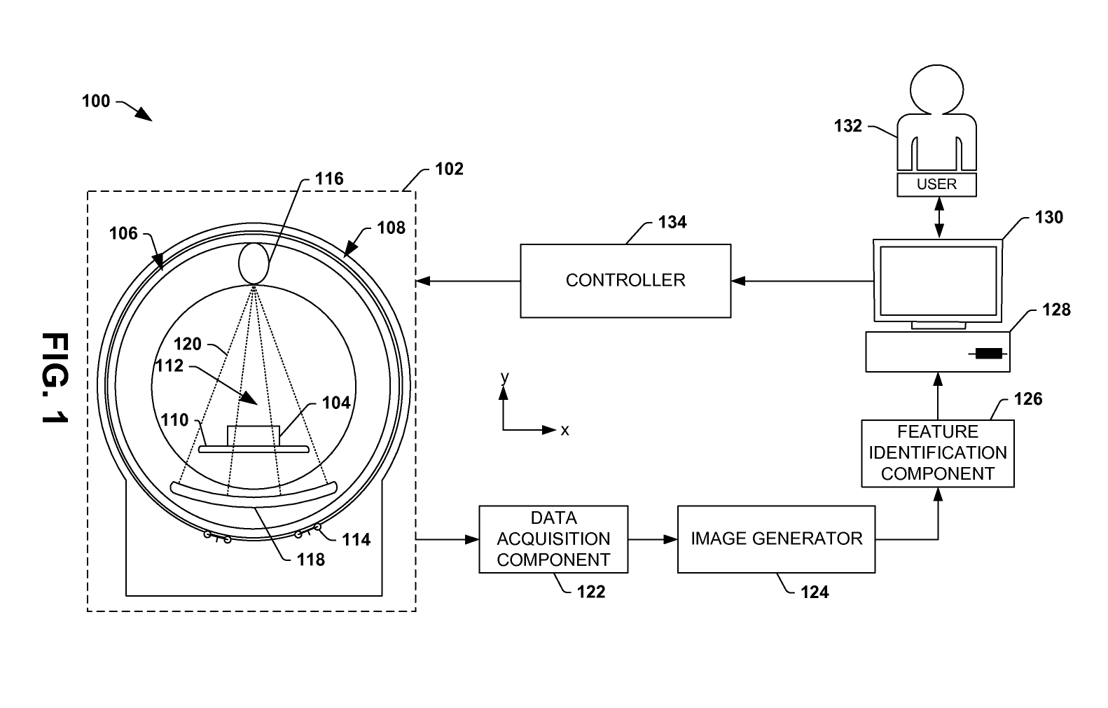

Referring to FIG. 1, an example radiation system 100 is illustrated for examining a composite product comprising a reinforcement cord to which a contrasting agent has been applied.

In the example environment 100, an examination unit 102 of the radiation system is configured to examine composite products 104, such a tire, wall structure, etc. The examination unit 102 may be configured similar to a CT system, line-scan system, single-photon emission computed tomography (SPECT) systems, digital projection systems, or other radiation system configured to generate images using radiation. By way of example, where the examination unit 102 is configured similar to a CT system, the examination unit 102 may comprise a rotating gantry 106 and a (stationary) support structure 108 (e.g., which may encase and/or surround at least a portion of the rotating gantry 106 (e.g., as illustrated with an outer, stationary ring, surrounding an outside edge of an inner, rotating ring)). During an examination of a composite product 104, the composite product 104 is placed on a support article 110, such as a bed or conveyor belt, for example, that may be translated into and/or through an examination region 112 (e.g., a hollow bore in the rotating gantry 106), where the composite product 104 is exposed to radiation 120.

The examination unit 102, or the rotating gantry 106 thereof, may comprise one or more radiation sources 116 (e.g., an ionizing radiation source such as an x-ray source or gamma-ray source) and one or more detector arrays 118. The detector array(s) 118 is typically mounted on a substantially diametrically opposite side of the rotating gantry 106 relative to the radiation source(s) 116, and during an examination of the composite product 104, the rotating gantry 106 (e.g., including the radiation source 116 and detector array 118) are rotated about the composite product 104 by a rotor 114 (e.g., belt, drive shaft, chain, roller truck, etc.). Where the radiation source(s) 116 and the detector array(s) 118 are mounted to the rotating gantry 106, a relative position between the detector array(s) 118 and the radiation source(s) 116 is substantially maintained during the rotation of the rotating gantry 106. In embodiments where the composite product 104 is translated during the examination in a direction substantially parallel to an axis about which the rotating gantry 106 rotates, a helical examination is performed on the composite product 104.

During the examination of the composite product 104, the radiation source(s) 116 emits cone-beam and/or fan-beam radiation 120 from a focal spot of the radiation source 116 (e.g., a region within the radiation source 116 from which radiation 120 emanates) into the examination region 112. Such radiation 120 may be emitted substantially continuously and/or may be emitted intermittently (e.g., a brief pulse of radiation 120 is emitted followed by a resting period during which the radiation source(s) 116 is not activated). Further, the radiation 120 may be emitted at a single energy spectrum or multi-energy spectrums depending upon, among other things, whether the radiation system is configured as a single-energy radiation system or a multi-energy (e.g., dual-energy) radiation system.

As the emitted radiation 120 traverses the composite product 104, the radiation 120 may be attenuated differently by different aspects of the composite product 104. Because different aspects attenuate different percentages of the radiation 120, the number of photons detected by respective detector cells of the detector array 118 may vary. For example, more dense aspects of the composite product 104, such as the reinforced cord comprising the contrasting agent, may attenuate more of the radiation 120 (e.g., causing fewer photons to impinge a region of the detector array(s) 118 shadowed by the more dense aspects) than less dense aspects, such as rubber.

Radiation detected by the detector array(s) 118 may be indirectly and/or directly converted into analog signals that can be transmitted from the detector array(s) 118 to a data acquisition component 122 operably coupled to the detector array(s) 118. The analog signal(s) may carry information indicative of the radiation detected by the detector array(s) 118 (e.g., such as an amount of charge measured over a sampling period, a detection time/location of respective photons, and/or an energy of respective photons). The data acquisition component 122 is configured to convert the analog signals output by the detector array(s) 118 into digital signals and/or to compile signals that were transmitted within a predetermined time interval, or measurement interval, using various techniques (e.g., integration, photon counting, etc.). The compiled signals are typically in projection space and are, at times, referred to as projections.

The projections and/or digital signals generated by the data acquisition component 122 may be transmitted to an image generator 124 configured to convert the data from projection space to image space using suitable analytical, iterative, and/or other image generation techniques (e.g., tomosynthesis reconstruction, back-projection, iterative reconstruction, etc.). Such images may depict a two-dimensional representation of the composite product 104 and/or a three-dimensional representation of the composite product 104.

A feature identification component 126 is configured to analyze the radiation image(s) generated by the image generator 124 and/or the projections generated by the data acquisition component 122 to identify specified features. For example, the feature identification component 126 may analyze the image(s) to identify reinforcement cords that are located at undesirable locations within the composite product 104 and/or reinforcement cords that comprise defects using analytic, iterative, or other feature identification techniques.

The example environment 100 also includes a terminal 128, or workstation (e.g., a computer), configured to receive image(s) from the image generator 124 and/or to receive information (e.g., results) from the feature identification component 126, which can be displayed on a monitor 130 to a user 132 (e.g., security personnel, medical personnel, etc.). In this way, the user 132 can inspect the image(s) to identify areas of interest within the composite product 104. The terminal 128 can also be configured to receive user input which can direct operations of the examination unit 102 (e.g., a speed of gantry rotation, an energy level of the radiation, etc.).

In the example environment 100, a controller 134 is operably coupled to the terminal 128. The controller 134 may be configured to control operations of the examination unit 102, for example. By way of example, in some embodiments, the controller 134 may be configured to receive information from the terminal 128 and to issue instructions to the examination unit 102 indicative of the received information (e.g., adjust a speed of a conveyor belt).

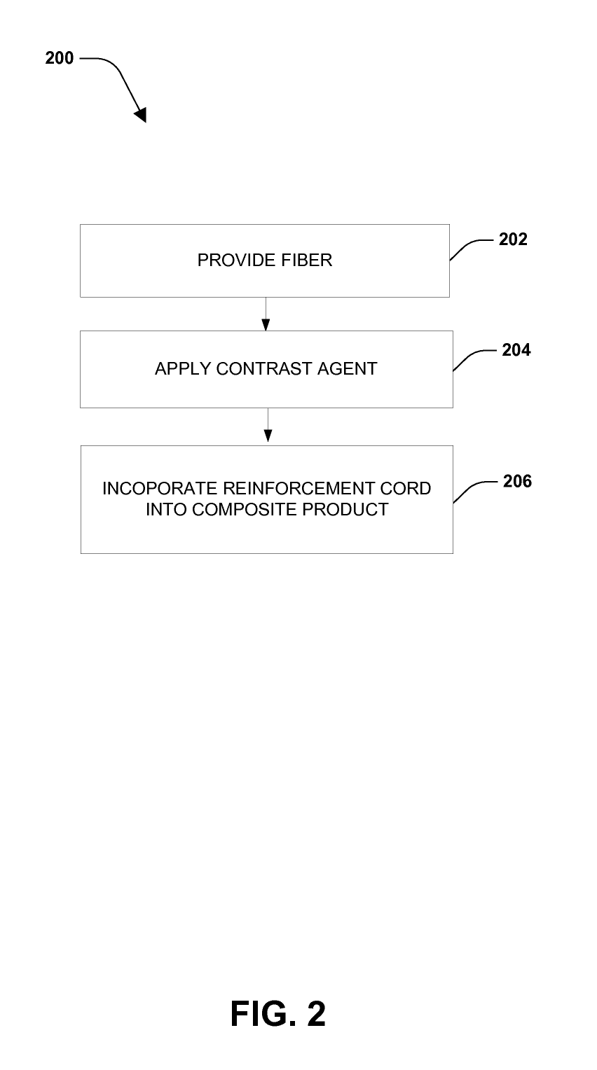

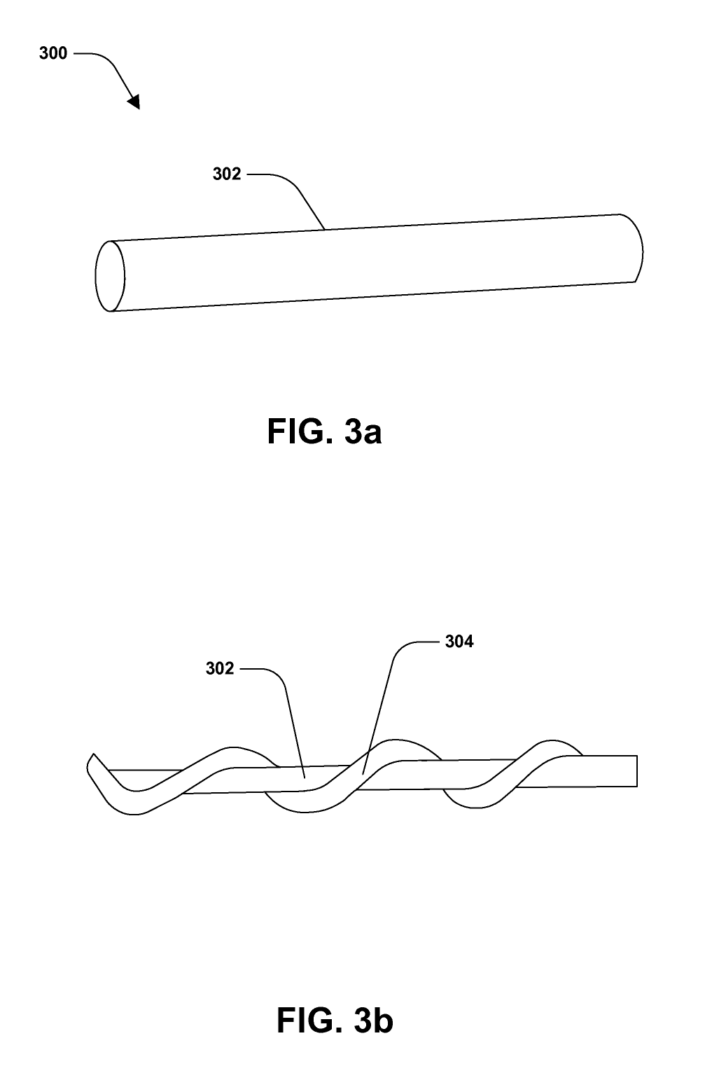

Referring to FIG. 2, a flow diagram of an example method 200 for fabricating a reinforcement cord 300 and incorporating the reinforcement cord 300 into a composite product according to some embodiments is provided. Referring also to FIGS. 3a-4b and 6, illustrated are various views of a reinforcement cord 300 at various stages of fabrication according to some embodiments, such as according to the method 200 of FIG. 2. In some embodiments, at least one reinforcement cord 300 is incorporated into a tire, as illustrated in FIG. 7. In some embodiments, additional processes are provided before, during, and/or after the method 200 of FIG. 2.

At 202, a first fiber 302 is provided, as illustrated in FIG. 3a. In some embodiments, the first fiber 302 includes at least one of polyester, cotton, rayon, nylon, polyamide, or glass. The polyester may be any polyester such as, but not limited to, polyethylene terephthalate. The polyamide may be any conventional polyamide material including aliphatic polyamide polymers such as, but not limited to, polyhexamethylene adipamide (nylon 66), polycaprolactam (nylon 6), polybutyrolactam (nylon 4), poly(9-aminononanoic acid) (nylon 9), polyenantholactam (nylon 7), polycapryllactam (nylon 8), polyhexamethylene sebacamide (nylon 6, 10), and/or the like, or blends thereof such as nylon 6,66. In some embodiments, the first fiber 302 may include highly aromatic polyamides that are derived from p-phenylenediamine and/or terephthaloyl chloride.

In some embodiments, the first fiber 302 has a first radiation attenuation coefficient. In some embodiments, the first fiber 302 has a first pixel value of between about 500 HU to about 1500 HU at 80 kVp.

A second fiber 304 may be wrapped or twisted around the first fiber 302, as illustrated in FIG. 3b. The second fiber 304 can be substantially the same or different than the first fiber 302. In some embodiments, the second fiber 304 includes at least one of polyester, cotton, rayon, nylon, polyamide, or glass. At least one of the first fiber 302 or the second fiber 304 may be a composite fiber. In some embodiments, at least one of the first fiber 302 or the second fiber 304 has a diameter of about 0.05 to about 2 mm. In some embodiments, a plurality of fibers is twisted into a bundle. In some embodiments, the bundle has a diameter of about 1 mm to about 5 mm

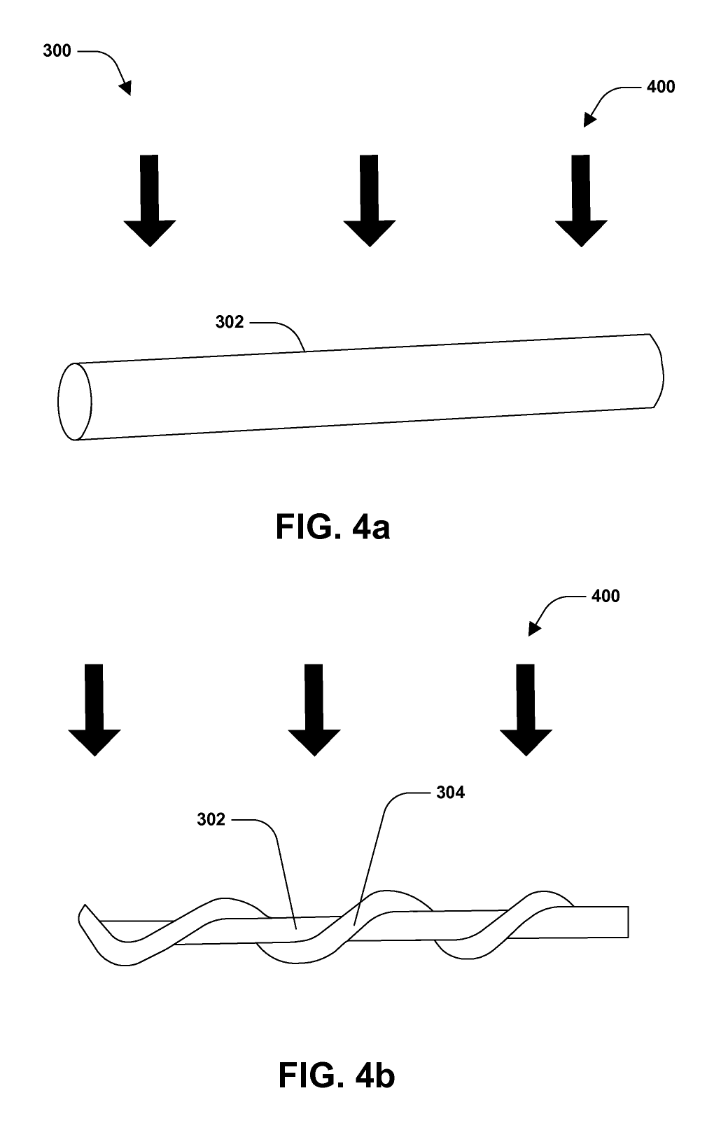

At 204, a contrast agent is applied to the first fiber 302 and/or the second fiber 304 to form the reinforcement cord 300, as illustrated in FIG. 4a and FIG. 4b. The contrast agent can be applied to the fibers 302, 304 by a process 400. In some embodiments, the process 400 includes at least one of a doping, implantation, coating and/or crosslinking process. In some embodiments, the doping process includes at least one of an immersion and/or vaporization process. For example, at least one of the first fiber 302 or the second fiber 304 can be immersed in an immersion solution containing, inter alia, the contrast agent. The immersion solution may also include a solvent, such as acetone, methyl acetate, ethyl acetate, toluene, hexane, pyridinium, ethanol, or other suitable solvents. In some embodiments, at least one of the first fiber 302 or the second fiber 304 is immersed in the immersion solution for between about 0.1 minute to about 48 hours. In some embodiments, the amount of the contrast agent applied to at least one of the first fiber 302 or the second fiber 304 is controlled by varying at least one of the solvent chosen or the amount of contrast agent in the immersion solution. For example, when the contrast agent is iodine, the solvent chosen can cause iodine to form iodine ions, which in turn could take up additional iodine ions to form polyiodine ions, thus creating additional bonding sites resulting in a greater iodine concentration.

The contrast agent can also be applied to at least one of the first fiber 302 or the second fiber 304 by any suitable vaporization process. For example, the contrast agent may be vaporized in a tube or other suitable vessel by the application of a heat source. In some embodiments, at least one of the first fiber 302 or the second fiber 304 is exposed to the vaporized contrast agent for a period of between about 0.1 minute to about 48 hours.

In some embodiments, the contrast agent can be applied to at least one of the first fiber 302 or the second fiber 304 as a coating formed on the surfaces of the first fiber 302 and/or the second fiber 304. The coating can be a film that is formed by applying and/or curing an aqueous solution comprising the contrast agent on at least one of the first fiber 302 or the second fiber 304 of the reinforcement cord 300.

The contrast agent can be any substance that enhances the contrast of at least one of the first fiber 302 or the second fiber 304 during a radiation imaging process, such as an x-ray examination and/or a gamma-ray examination by the radiation system 100. In some embodiments, the contrast agent includes an element with an atomic number of 53 or greater. In some embodiments, the contrast agent includes at least one of iodine, barium, bismuth, gadolinium, gold, or thorium.

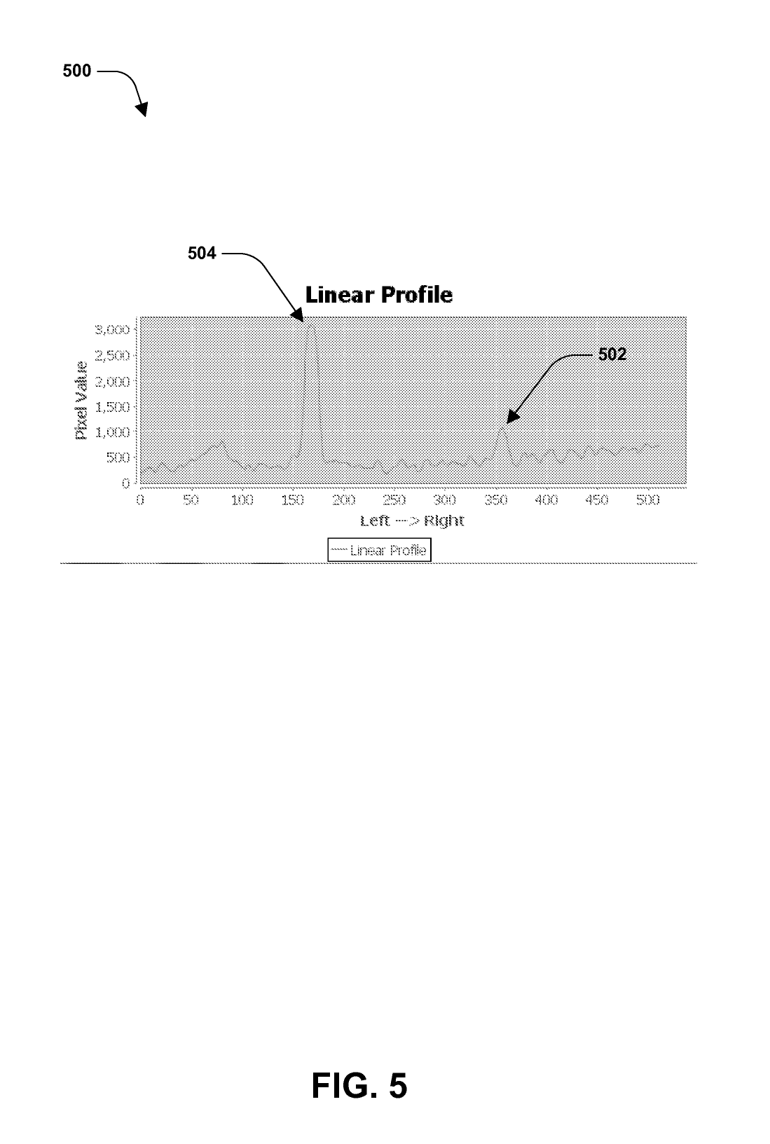

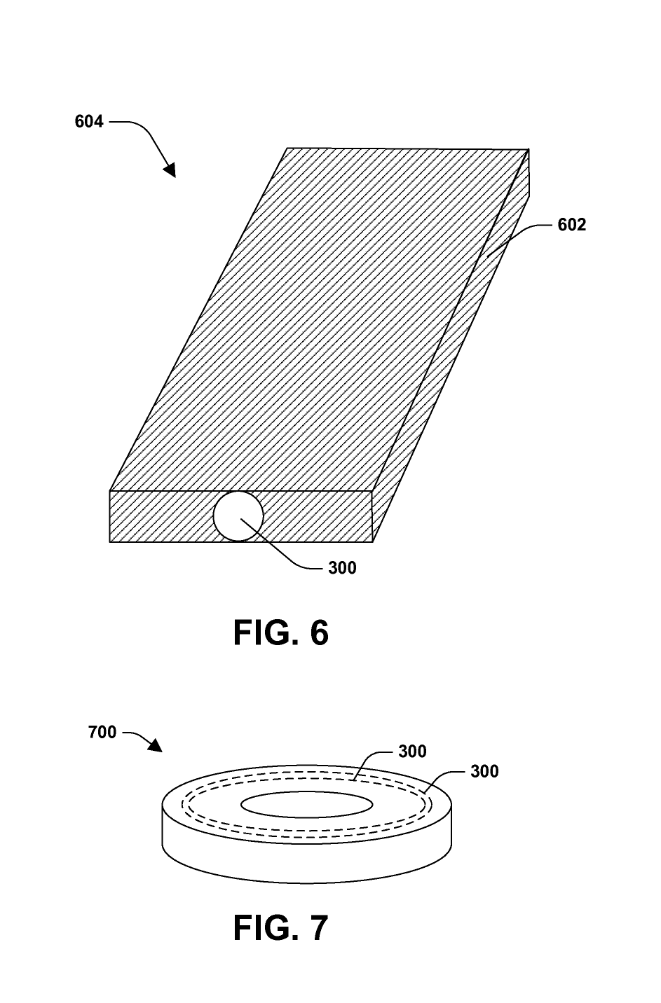

In some embodiments, the contrast agent has a second radiation attenuation coefficient. In some embodiments, the second radiation attenuation coefficient is different (e.g., greater or lesser) than the first radiation attenuation coefficient. When the contrast agent has a greater radiation attenuation coefficient than that of the first fiber 302 without the contrast agent, the contrast agent may increase and/or enhance the pixel value of the first fiber 302 during a radiation examination over that of the first fiber 302 without the contrast agent. FIG. 5 illustrates a projection 500, such as may be yielded from the data acquisition component 122. A first peak 502 represents the first fiber 302 without the contrast agent and a second peak 504 represents the first fiber 302 with the contrast agent applied thereto. In some embodiments, the first peak 502 has a first pixel value between about 500 HU to about 1500 HU at 80 kVp and the second peak 504 has a second pixel value is between about 1600 HU to about 3500 HU at 80 kVp.

As illustrated by the CT scan 500, the first fiber 302 with the contrast agent applied thereto has a marked increase in pixel value (e.g., as represented by the second peak 504) over that of the first fiber 302 without the contrast agent (e.g., as represented by the first peak 502). Thus, by applying the contrast agent to the first fiber 302 and, as a result, increasing the pixel value for the first fiber 302, one would be able to more easily and/or accurately inspect and differentiate the reinforcement cord 300 from the surrounding materials by a radiation examination.

In some embodiments, the increase in pixel value for the reinforcement cord 300 can be controlled by increasing or decreasing the concentration of the contrast agent applied to the fibers and/or the composition of the contrast agent. In some embodiments, the contrast agent is applied to the fibers at a concentration that increases the pixel value by about 100 HU to about 600 HU. In some embodiments, the contrast agent is applied to the fibers at a concentration that increases the pixel value by about 200 HU to about 300 HU.

In some embodiments, the first fiber 302 and the second fiber 304 are formed into a bundle after the contrast agent is applied. In other embodiments, the first fiber 302 and the second fiber 304 are formed into a bundle before the contrast agent is applied. It is to be appreciated that while the radiation attenuation coefficient of the contrast agent is at times referred to as being greater than the radiation attenuation coefficient of the fiber and/or chord, the instant application including the scope of the appended claims is not to be so limited. For example, the radiation attenuation coefficient of the contrast agent may be less than the radiation attenuation coefficient of the fiber and/or chord.

At 206 in the example method 200, the reinforcement cord 300 is incorporated into a composite product, as illustrated in FIG. 6 and FIG. 7. To incorporate the reinforcement cord 300 into a composite product, such as a tire 700, the reinforcement cord 300 may first be incorporated into a matrix 602 to form a reinforcement structure 604. The matrix 602 can be any rubber and/or polymeric material into which the reinforcement cord 300 can be partially or totally embedded. In some embodiments, the matrix 602 keeps multiple reinforcement cords in a fixed orientation and placement with respect to one other. In some embodiments, the matrix 602 includes at least one of a thermoset material, such as a rubber or a thermoplastic material, such as at least one of a thermoplastic vulcanisate or a copolyetherester. When the composite structure or product 604 is a tire, the matrix 602 can be at least one of a carcass ply, a bead reinforcement chafer, such as a composite strip for low sidewall reinforcement, a reinforcement layer, and/or a belt structure, for example.

FIG. 7 illustrates a tire 700 having one or more reinforcement cords 300 incorporated therein. Although not illustrated in detail, the tire 700 may comprise at least one carcass ply, where a carcass ply may comprise one or more reinforcing elements, such as a plurality reinforcement cords 300 arranged parallel (e.g., or otherwise) to one other. Opposite lateral edges of the carcass ply may be associated with one or more bead structures including at least one of a bead core or a bead filler. In some embodiments, the bead core can be enclosed in a bead, defined along an inner circumferential edge of the tire 700. The bead filler can be located proximate the bead core. A reinforcing layer may be wound around the bead core and the bead filler so as to at least partially envelope the bead core and the bead filler. The reinforcing layer may comprise a plurality of reinforcing elements, such as one or more reinforcement cords embedded therein. A belt structure may be applied along the circumference of the carcass ply. The belt structure may comprise a plurality of reinforcing elements, such as one or more reinforcement cords embedded therein.

The reinforcement cord 300 is particularly suited for use in tires, such as passenger tires, truck tires, motorcycle tires, and/or other tires. Moreover, the reinforcement cord 300 is also particularly suited for improving quality control of a tire during and/or after the manufacturing process via analysis by a radiation examination, such as a CT scan. The enhanced contrast of the reinforcement cord 300 may allow for improved non-destructive detection of potential defects, such as wrinkles, cuts, fraying and/or gaps inside of a tire. To this end, the reinforcement cord 300 is particularly useful in obtaining a high contrast image in the sub 100 micron range, for example.

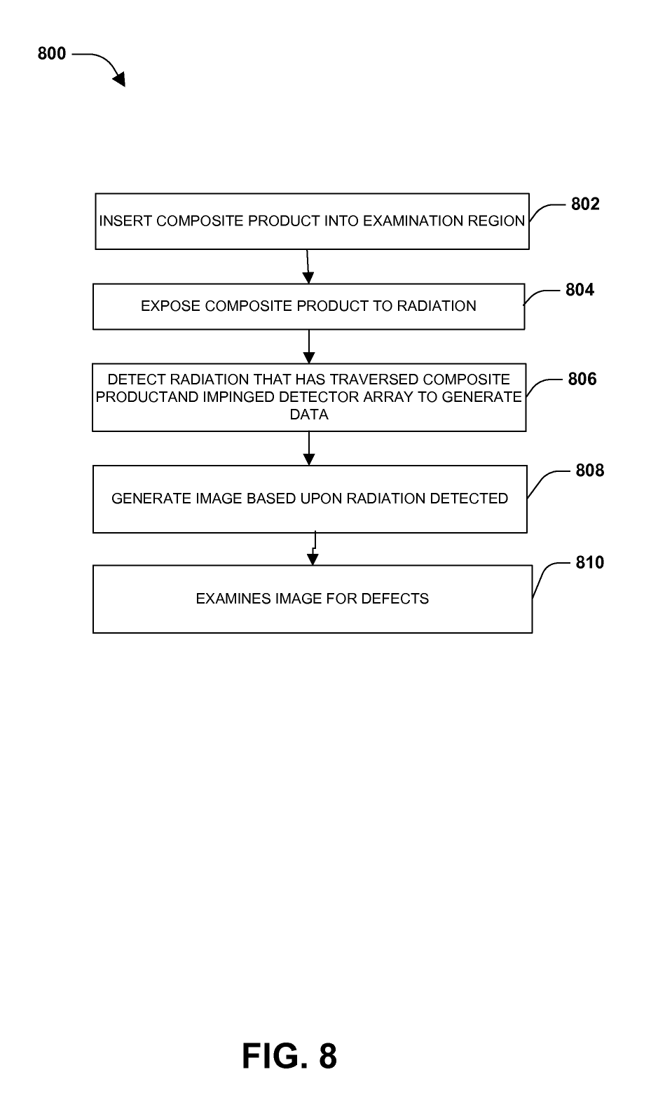

Referring to FIG. 8, a flow diagram of an example method 800 for examining a composite product, such as a tire, via a radiation examination, such as a CT scan, is provided. In some embodiments, the method 800 can be used to examine a composite product for defects. At 802 in the example method 800, a composite product is inserted into an examination region. At 804, the composite product is exposed to radiation. In some embodiments, the composite product is rotated about an axis of rotation while concurrently exposing the composite product to radiation and/or while concurrently translating the composite product through the examination region. In some embodiments, the axis of rotation is substantially perpendicular to a detection surface of a detector array of a radiation system configured to examine the composite product. In other embodiments, the axis of rotation is angled at an angle of other than 90 degrees relative to the detection surface.

At 806, radiation that has traversed the composite product and impinged the detector array is detected to generate data.

At 808, an image is generated based upon the radiation and/or data that is detected/generated at 806.

At 810, the image is examined to determine if the composite product is free or substantially free of defects. In some embodiments, the defects that can be observed include wrinkles, cuts, fraying and/or gaps inside of a tire. It will be appreciated that the examination (e.g., and defect identification and/or other feature identification) may be performed programmatically, such as by a feature identification component and/or by a user.

In some embodiments, by incorporating the reinforcement cord 300 into the composite product, a condition of the composite product can be more readily and/or accurately attained because the contrast agent has a different radiation attenuation coefficient than that of the surrounding materials (e.g. matrix). In some embodiments, the reinforcement cord 300 can facilitate obtaining a high contrast image in the sub 100 micron range by providing enhanced contrast.

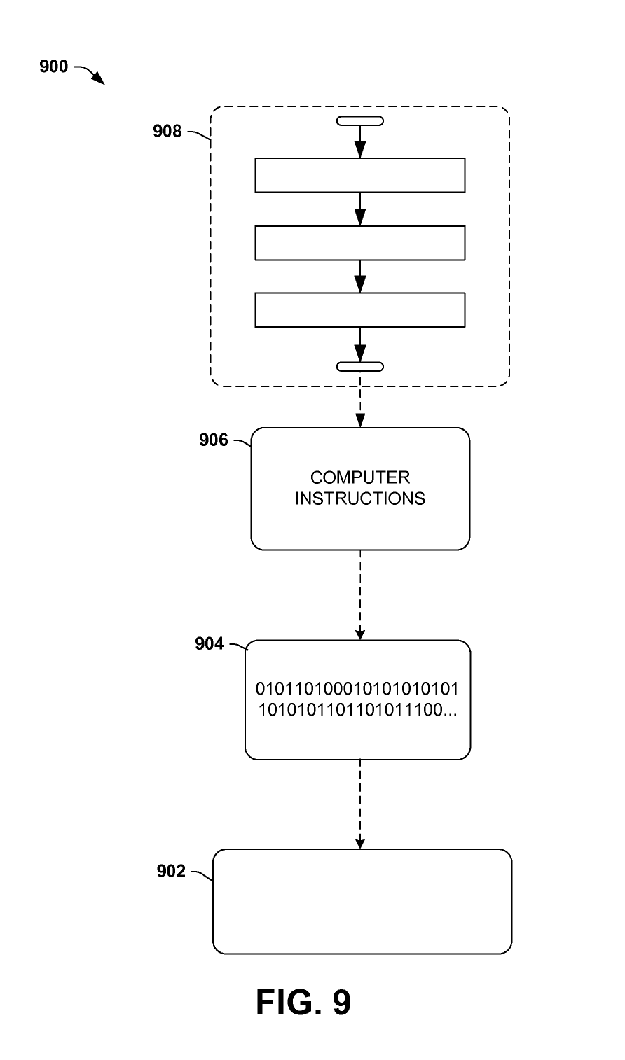

Still another embodiment involves a computer-readable medium comprising processor-executable instructions configured to implement one or more of the techniques presented herein. An example computer-readable medium that may be devised in these ways is illustrated in FIG. 9, wherein the implementation 900 comprises a computer-readable medium 902 (e.g., a CD-R, DVD-R, or a platter of a hard disk drive), on which is encoded computer-readable data 904. This computer-readable data 904 in turn comprises a set of processor-executable instructions 906 configured to operate according to one or more of the principles set forth herein. In one such embodiment 900, the processor-executable instructions 906 may be configured to perform an operation 908, such as at least some of the example method 100 of FIG. 1 and/or at least some of the example method 800 of FIG. 8, for example, when executed via a processing unit. In another such embodiment, the processor-executable instructions 906 may be configured to implement a system, such as at least some of the example environment 100 of FIG. 1, for example. Many such computer-readable media may be devised by those of ordinary skill in the art that are configured to operate in accordance with one or more of the techniques presented herein.

Although the subject matter has been described in language specific to structural features or methodological acts, it is to be understood that the subject matter of the appended claims is not necessarily limited to the specific features or acts described above. Rather, the specific features and acts described above are disclosed as embodiment forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. The claimed subject matter may be implemented as a method, apparatus, or article of manufacture (e.g., as software, firmware, hardware, or any combination thereof).

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. (e.g., “a first channel and a second channel” generally corresponds to “channel A and channel B” or two different (or two identical) channels or the same channel).

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A tire comprising:
a matrix; and
a reinforcement cord in the matrix, the reinforcement cord comprising:
a first fiber having a first radiation attenuation coefficient; and
a contrast agent applied to the first fiber, the contrast agent having a second radiation attenuation coefficient different than that of the first radiation attenuation coefficient.

2. The tire of claim 1, the matrix comprising:
at least one of a plastic, a rubber or a polymer.

3. The tire of claim 1, the contrast agent comprising:
at least one of iodine, barium, bismuth, gadolinium, gold or thorium.

4. The tire of claim 1, the contrast agent comprising:
an element with an atomic number of 53 or greater.

5. The tire of claim 1, the first fiber comprising:
at least one of polyester, cotton, rayon, nylon, polyamide, metal, or glass.

6. The tire of claim 1, comprising:
a second fiber twisted around the first fiber.

7. The tire of claim 1, the second radiation attenuation coefficient greater than the first radiation attenuation coefficient.

8. The tire of claim 1, wherein the reinforcement cord has a diameter of about 0.1 to about 2 mm

9. A reinforcement cord comprising:
a first fiber having a first radiation attenuation coefficient; and
a contrast agent applied to the first fiber, the contrast agent having a second radiation attenuation coefficient different than that of the first radiation attenuation coefficient.

10. The reinforcement cord of claim 9, the contrast agent comprising:
at least one of iodine, barium, bismuth, gadolinium, gold, or thorium.

11. The reinforcement cord of claim 9, the contrast agent comprising:
an element with an atomic number of 53 or greater.

12. The reinforcement cord of claim 9, the first fiber comprising:
at least one of polyester, cotton, rayon, nylon, polyamide, metal, or glass.

13. The reinforcement cord of claim 9, comprising:
a second fiber twisted around the first fiber.

14. The reinforcement cord of claim 9, the second radiation attenuation coefficient greater than the first radiation attenuation coefficient.

15. The reinforcement cord of claim 9, having a diameter of about 0.1 to about 2 mm.

16. The reinforcement cord of claim 9, wherein the reinforcement cord is part of a composite product.

17. A method of manufacturing a reinforcement cord comprising:
providing a first fiber having a first radiation attenuation coefficient; and
applying a contrast agent to the first fiber, the contrast agent having a second radiation attenuation coefficient different than that of the first radiation attenuation coefficient.

18. The method of claim 17, wherein the applying comprises coating the first fiber with the contrast agent.

19. The method of claim 17, wherein the applying comprises providing for absorption of the contrast agent by the first fiber.

20. The method of claim 17, wherein the applying comprises doping the first fiber with the contrast agent.
